(19) United States
(12) Patent Application Publication
(10) Pub. No.: US 2023/0117781 A1
(43) Pub. Date: Apr. 20, 2023

(54) OPTIMIZATION FUNCTION GENERATION APPARATUS, OPTIMIZATION FUNCTION GENERATION METHOD, AND PROGRAM

(71) Applicant: NIPPON TELEGRAPH AND TELEPHONE CORPORATION, Tokyo (JP)

(72) Inventors: Kazuhiro MIYAHARA, Musashino-shi, Tokyo (JP); Keitaro HORIKAWA, Musashino-shi, Tokyo (JP); Kinya TOMITA, Musashino-shi, Tokyo (JP)

(73) Assignee: NIPPON TELEGRAPH AND TELEPHONE CORPORATION, Tokyo (JP)

(21) Appl. No.: 17/796,267

(22) PCT Filed: Mar. 3, 2020
(86) PCT No.: PCT/JP2020/008821

§ 371 Date: Jul. 29, 2022

(51) Int. Cl. G06N 10/60

(52) U.S. Cl. CPC G06N 10/60

(57) ABSTRACT

A technology for generating an optimization function for solving a combinatorial optimization problem, which can be expressed by using fewer quantum bytes is provided. An optimization function generation apparatus includes an input setting unit that sets an input of a combinatorial optimization problem, and an optimization function generation unit that generates an optimization function for solving the combinatorial optimization problem using the input, in which N is an integer equal to or greater than 1, Idx={0, . . . , N−1} is a set of indexes indicating N states, and i satisfies i ε Idx, and the optimization function generation unit generates an optimization function using a quantum byte obtained by performing encoding so that digits when an index i is expressed as a binary number each match a corresponding quantum bit included in a quantum byte that is a sequence of log₂N quantum bits.

### TECHNICAL FIELD

The present invention relates to a technology for generating an optimization function for solving a combinatorial optimization problem with a quantum computer.

### BACKGROUND ART

It is difficult to efficiently solve a combinatorial optimization problem with a von Neumann type computer that is widely used today. Thus, in recent years, research and development of quantum annealing machines and Ising machines, which are computers capable of solving combinatorial optimization problems more efficiently than a von Neumann computer, has been promoted.

These new computers receive an input of an optimization function obtained by expressing a target combinatorial optimization problem as an objective function of quadratic unconstrained binary optimization (QUBO) or an Ising Hamiltonian to calculate a solution to the problem at high speed.

In the related art, schemes have been developed for designing a traveling salesman problem and a graph coloring problem as an objective function of QUBO (see NPL 1 and NPL 2).

In a combinatorial optimization problem, a condition of “one of N options” often appears. For example, in the traveling salesman problem, an M-th visited city is one of N cities, and in the graph coloring problem using N colors for coloring, a color assigned to a certain area is one of the N colors. Currently, in modeling based on QUBO, it is necessary to use N quantum bits when a condition “one of N options” is desired to be expressed. For example, when a quantum bit x₁ that is “1” if an i-th option is adopted and “0” otherwise is used, an equation OnlyOne indicating that there is only one quantum bit having a value “1” among quantum bits x₁, . . . , x_{N} can be defined as follows, for example.

OnlyOne(x₁, . . . ,x_{N})=(x₁+x_{N}−1)² [Math. 1]

### CITATION LIST

### Non Patent Literature

NPL 1: Traveling salesman problem, [online], [retrieved on Jan. 17, 2020], Internet <URL: https://quantum.fixstars.com/techresouces/application/traveling-salesman/index.html>
NPL 2: Graph coloring problem, [online], [retrieved on Jan. 17, 2020], Internet <URL: https://quantum.fixstars.com/techresouces/application/graph-coloring/index.html>

### SUMMARY OF THE INVENTION

### Technical Problem

However, in the equation OnlyOne defined above, most of values of the quantum bits x₁, . . . , x_{N} are “0”, which is wasteful.

Thus, an object of the present invention is to provide a technology for generating an optimization function for solving a combinatorial optimization problem, which can be expressed by using fewer quantum bits.

### Means for Solving the Problem

According to one aspect of the present invention, an optimization function generation apparatus includes: an input setting unit that sets an input of a combinatorial optimization problem; and an optimization function generation unit that generates an optimization function for solving the combinatorial optimization problem using the input, in which N is an integer equal to or greater than 1, Idx={0, . . . , N−1} is a set of indexes indicating N states, and i satisfies i ε Idx, and the optimization function generation unit generates the optimization function using a quantum byte obtained by performing encoding so that digits when an index i is expressed as a binary number each match a corresponding quantum bit included in a quantum byte that is a sequence of log₂N quantum bits.

### Effects of the Invention

According to the present invention, it is possible to generate an optimization function for solving a combinatorial optimization problem, which can be expressed using fewer quantum bits.

### BRIEF DESCRIPTION OF DRAWINGS

FIG. 1 is a diagram illustrating an example of input of a scheduling problem.

FIG. 2 is a diagram illustrating an example of output of the scheduling problem.

FIG. 3 is a diagram illustrating an example of input of a bandwidth allocation planning problem.

FIG. 4 is a diagram illustrating an example of a relationship between a path and an edge.

FIG. 5 is a diagram illustrating an example of output of a bandwidth allocation planning problem.

FIG. 6 is a block diagram illustrating a configuration of an optimization function generation apparatus 100.

FIG. 7 is a flowchart illustrating an operation of the optimization function generation apparatus 100.

FIG. 8 is a diagram illustrating an example of a functional configuration of a computer that realizes each apparatus according to an embodiment of the present invention.

### DESCRIPTION OF EMBODIMENTS

Hereinafter, embodiments of the present invention will be described in detail.

Constituent units having the same function are denoted by the same reference signs, and repeated description will be omitted.

A notation method in this specification will be described prior to description of each embodiment.

A caret (∧) indicates a superscript. For example, x^{y∧z} indicates that y^{z} is a superscript for x, and x_{y∧z} indicates that y^{z} is a subscript for x. Further, an underscore (_) indicates a subscript. For example, x^{y}-z indicates that y^{z} is a superscript for x, and x_{y}_z indicates that y^{z} is a subscript for x.

Superscripts “∧” in ∧x and “˜” in ˜x for a certain character x should be written directly above “x”, but ∧x and ˜x are described due to the limitation of a description notation in the specification.

### TECHNICAL BACKGROUND

A scheme for designing an objective function of QUBO using quantum bits in the related art uses a method of expressing basic constraint equations by associating N states with a sequence of N quantum bits x₀, x₁, . . . , x_{N-1}. A desired objective function is designed by combining these basic constraint equations to express various constraints. For example, a constraint requiring the quantum byte sequence x₀, x₁, . . . , x_{N-1} to be equal to a quantum byte sequence y₀, y₁, . . . , y_{N-1} can be expressed by an equation Σᵢ₌₀^{N-1}(xᵢ-yᵢ)².

However, with such a design scheme, most of values of the quantum bits x₀, x₁, . . . , x_{N-1} are 0 and this is wasteful. Thus, the embodiment of the present invention employs a method of expressing N states using a sequence of log₂N quantum bits by combining a plurality of quantum bits as each digit of a binary number, that is, a method of encoding and expressing N states using a sequence of log₂N quantum bits. Hereinafter, this sequence of quantum bits is referred to as a quantum byte. By designing the objective function using a quantum byte, it is possible to design the objective function with fewer quantum bits.

Thus, hereinafter, a coding method using a quantum byte will be first described, and then a design of a basic constraint equation using a quantum byte will be described.

Hereinafter, some symbols are defined for a quantum byte \vec{ }x, which is a sequence of quantum bits for expressing N states (N is an integer equal to or greater than 1). \vec{ }x(i) is assumed to indicate quantum bits of an i-th digit from the bottom when the quantum byte \vec{ }x is treated as a binary number. Further, |\vec{ }x| is assumed to indicate a length of the quantum byte \vec{ }x (that is, the number of quantum bits constituting the quantum byte \vec{ }x). It is assumed that #(\vec{ }x) indicates an integer expressed by the quantum byte \vec{ }x. Then, the integer #(\vec{ }x) expressed by the quantum byte \vec{ }x, which is a sequence of quantum bits for expressing N states, is expressed by the following equation.

$$\begin{matrix}[ Math . 2 ] & \\ \# ( \vec{x} ) = {\sum }_{0 \leq i < ⌈ {log}_{2} N ⌉ - 1} {2}^{i} \vec{x} ( i ) + ( N - {2}^{⌈ {log}_{2} N ⌉ - 1} ) \vec{x} ( ⌈ {log}_{2} N ⌉ - 1 ) & ( 1 )\end{matrix}$$

In Equation (1), a ceiling function is used, but the ceiling function may also be expressed as ceiling(x).

In other words, under the precondition that N is an integer equal to or greater than 1, Idx={0, . . . , N-1} is a set of indexes indicating N states, and i satisfies i εIdx, encoding is performed so that digits when the index i is expressed as a binary number each match a corresponding quantum bit included in a quantum byte, which is a sequence of log₂N quantum bits, thereby obtaining the quantum byte.

Further, QByte (N) is assumed to indicate a set of quantum bytes indicating integers equal to or greater than 0 and smaller than N.

Hereinafter a design of the basic constraint equation using a quantum byte will be described. Here, it is assumed that the constraint equation indicates a state in such a manner that a constraint corresponding to the equation is satisfied if the value of the equation is 0, and the constraint corresponding to the equation is not satisfied if the value of the equation is greater than 0.

Constraint Equation Exist A constraint equation Exist(\vec{ }x, flag) is an equation indicating that 1 being included in the quantum bits constituting the quantum byte \vec{ }x is equivalent to the quantum bit flag being 1, and the equation is calculated as follows.

$$\begin{matrix}[ Math . 3 ] & \\ Exist ( \vec{x} , flag ) = {( {\sum }_{0 \leq i < L} \vec{x} ( i ) - ( flag {\sum }_{0 \leq i < ⌈ {log}_{2} N ⌉} {2}^{i} {a}_{i} ) )}^{2} + {\sum }_{0 \leq i < L - 1} ( ( 1 - flag ) {a}_{i} ) & ( 2 )\end{matrix}$$

Here, L=\vec{ }x. Further, aᵢ is an auxiliary variable. The auxiliary variable is a variable (quantum byte) indicating a quantum state, which has a value of 1 or 0.

Equation (2) will be described. A first term (Σᵢ\vec{ }x(i)−(flag+Σᵢ2ⁱaᵢ))² on the right side of Equation (2) is a constraint requiring Σᵢ\vec{ }x(i) to match flag+Σᵢ2ⁱaᵢ. On the other hand, because a second term Σᵢ(1-flag)aᵢ on the right side of Equation (2) violates the constraint if both flag=0 and aᵢ=1 are valid, the quantum bit flag becomes 1 in preference to the auxiliary variable aᵢ. Thus, the constraint equation Exist indicates a constraint requiring that 1 being included in the quantum bits constituting the quantum byte \vec{ }x be equivalent to the quantum bit flag being 1.

Constraint Equation ForAll

A constraint equation ForAll(\vec{ }x, flag) is an equation indicating that all the quantum bits constituting the quantum byte \vec{ }x being 1 is equivalent to the quantum bit flag being 1, and the equation is calculated as follows.

$$\begin{matrix}[ Math . 4 ] & \\ For All ( \vec{x} , flag ) = {( {\sum }_{0 \leq i < L} ( 1 - \vec{x} ( i ) ) - ( ( 1 - flag ) + {\sum }_{0 \leq i < ⌈ {log}_{2} N ⌉} {2}^{i} {a}_{i} ) )}^{2} + {\sum }_{0 \leq i < L - 1} ( flag ⋆ {a}_{i} ) & ( 3 )\end{matrix}$$

Here, L=x. Further, aᵢ is an auxiliary variable.

Equation (3) will be described. The right-hand side of Equation (3) is an inversion of the quantum byte \vec{ }x and a value of the quantum bit flag (specifically, 0 and 1) on the right side of Equation (2) of the constraint equation Exist. Thus, “0 is included in the quantum bits constituting the quantum byte \vec{ }x⇔the quantum bit flag is 0”, and “0 is not included in the quantum bits constituting the quantum byte \vec{ }x⇔the quantum bit flag is 1”. Thus, the constraint equation ForAll indicates a constraint requiring that all the quantum bits constituting the quantum byte \vec{ }x being 1 be equivalent to the quantum bit flag being 1.

Constraint Equation Equal

A constraint equation Equal(\vec{ }x, \vec{ }y, flag) is an equation indicating that #(\vec{ }x)=#(\vec{ }y) being valid for the quantum bytes \vec{ }x and \vec{ }y is equivalent to the quantum bit flag being 1, and the equation is calculated as follows.

$$\begin{matrix}[ Math . 5 ] & \\ Equal ( x , y , flag ) = {( ( \# ( x ) - \# ( y ) + {2}^{L} ) - {\sum }_{0 \leq i < L - 1} {2}^{i} {a}_{i} )}^{2} + Exist ( ( {a}_{0} , {a}_{1} , … , {a}_{L - 1} ) , 1 - flag ) & ( 4 )\end{matrix}$$

Here, L=|\vec{ }x|=|\vec{ }y|. Further, aᵢ is an auxiliary variable.

Equation (4) will be described. When #(\vec{ }x)=#(\vec{ }y), #(\vec{ }x)−#(\vec{ }y)+_{2L}−Σ2¹aᵢ=0 requires (a₀, a₁, . . . , a_{L-1}, a_{L})=(0, 0, . . . , 0, 1). On the other hand, when (a₀, a₁, . . . , a_{L-1})=(0, 0, . . . , 0), #(\vec{ }x)−#(\vec{ }y)+2^{L}−Σ2ⁱaᵢ=0 requires #(\vec{ }x)=#(\vec{ }y). Further, because Exist((a₀, a₁, . . . , a_{L-1}), 1-flag)=0 when “1 is included in quantum bits a₀, a₁, . . . , a_{L-1} ⇔1−flag=1 (that is, flag=0)”, this is when “1 is not included in quantum bits a₀, a₁, . . . , a_{L-1}⇔flag=1”. Thus, the constraint equation Equal(\vec{ }x, \vec{ }y, flag) is an equation indicating that a constraint requiring that #(\vec{ }x)=#(\vec{ }y) being valid for the quantum bytes \vec{ }x and \vec{ }y be equivalent to the quantum bit flag being 1.

Constraint Equation LessThan

A constraint equation LessThan(\vec{ }x, \vec{ }y, flag) is an equation indicating that #(\vec{ }x)<#(\vec{ }y) being valid for the quantum bytes \vec{ }x and \vec{ }y is equivalent to the quantum bit flag being 1, and the equation is calculated as follows.

$$\begin{matrix}[ Math . 6 ] & \\ LessThan ( \vec{x} , \vec{y} , flag ) = {( ( \# ( \vec{x} ) - \# ( \vec{y} ) + {2}^{L} ) - ( {\sum }_{0 \leq i < L} {2}^{i} {a}_{i} + {2}^{L} ( 1 - flag ) ) )}^{2} & ( 5 )\end{matrix}$$

Here, L=|\vec{ }x|=|\vec{ }y|. Further, aᵢ is an auxiliary variable.

Equation (5) will be described. When flag=1, in order for the expression #(\vec{ }x)−#(\vec{ }y)+_{2L} and the expression Σᵢ2ⁱaᵢ+_{2L}(1−flag) to be equal to each other, #(\vec{ }x)<#(\vec{ }y) is required because Σᵢ2ⁱaᵢ<_{2L}. On the other hand, when flag=0, in order for the expression #(\vec{ }x)−#(\vec{ }y)+_{2L} and the expression Σᵢ2ⁱaᵢ+_{2L}(1-flag) to be equal to each other, and thus, #(\vec{ }x)≥#(\vec{ }y) is required because Σᵢ2ⁱaᵢf≥0. Thus, the constraint equation LessThan is an equation indicating a constraint requiring that #(\vec{ }x)<#(\vec{ }y) being valid for the quantum bytes \vec{ }x and \vec{ }y be equivalent to the quantum bit flag being 1.

The constraint equation LessThan(\vec{ }x, N, flag) is an equation indicating that #(\vec{ }x)<N being valid for the quantum byte \vec{ }x and an integer N is equivalent to the quantum bit flag being 1, and the equation is calculated as follows.

$$\begin{matrix}[ Math . 7 ] & \\ LessThan ( \vec{x} , N , flag ) = {( ( \# ( \vec{x} ) - N + {2}^{L} ) - ( {\sum }_{0 \leq i < L} {2}^{i} {a}_{i} + {2}^{L} ( 1 - flag ) ) )}^{2} & {( 5 )}^{′}\end{matrix}$$

Here, L=|\vec{ }x|. Further, aᵢ is an auxiliary variable.

Constraint Equation GreaterThan

A constraint equation GreaterThan(\vec{ }x, \vec{ }y, flag) is an equation indicating that #(\vec{ }x)>#(\vec{ }y) being valid for the quantum bytes \vec{ }x and \vec{ }y is equivalent to the quantum bit flag being 1, and the equation is calculated as follows.

[Math. 8]

GreaterThan(\vec{x},\vec{y},flag)=LessThan(\vec{y},\vec{x},flag) (6)

Using Equation (5), Equation (6) is transformed as follows.

$$\begin{matrix}[ Math . 9 ] & \\ GreaterThan ( \vec{x} , \vec{y} , flag ) = {( ( \# ( \vec{y} ) - \# ( \vec{x} ) + {2}^{L} ) - ( {\sum }_{0 \leq i < L} {2}^{i} {a}_{i} + {2}^{L} ( 1 - flag ) ) )}^{2} & {( 6 )}^{′}\end{matrix}$$

Here, L=|\vec{ }x|=|\vec{ }y|. Further, aᵢ is an auxiliary variable.

Constraint Equation LessThanEqual

A constraint equation LessThanEqual(\vec{ }x, \vec{ }y, flag) is an equation indicating that #(\vec{ }x) #(\vec{ }y) being valid for the quantum bytes \vec{ }x and \vec{ }y is equivalent to the quantum bit flag being 1, and the equation is calculated as follows.

[Math. 10]

LessThanEqual(\vec{x},\vec{y},flag)=GreaterThan(\vec{x},\vec{y},1−flag) (7)

Using Equation (5), Equation (7) is transformed as follows.

$$\begin{matrix}[ Math . 11 ] & \\ LessThanEqual ( \vec{x} , \vec{y} , flag ) = {( ( \# ( \vec{y} ) - \# ( \vec{x} ) + {2}^{L} ) - ( {\sum }_{0 \leq i < L} {2}^{i} {a}_{i} + {2}^{L} flag ) )}^{2} & {( 7 )}^{′}\end{matrix}$$

Here, L=|\vec{ }x|=|\vec{ }y|. Further, aᵢ is an auxiliary variable.

Constraint Equation GreaterThanEqual

A constraint equation GreaterThan Equal(\vec{ }x, \vec{ }y, flag) is an equation indicating that #(\vec{ }x)≥#(\vec{ }y) being valid for the quantum bytes \vec{ }x and \vec{ }y is equivalent to the quantum bit flag being 1, and the equation is calculated as follows.

[Math. 12]

GreaterThanEqual(\vec{x},\vec{y},flag)=LessThan(\vec{x},\vec{y},1−flag) (8)

Using Equation (5), Equation (8) is transformed as follows.

$$\begin{matrix}[ Math . 13 ] & \\ GreaterThanEqual ( \vec{x} , \vec{y} , flag ) = {( ( \# ( \vec{x} ) - \# ( \vec{y} ) + {2}^{L} ) - ( {\sum }_{0 \leq i < L} {2}^{i} {a}_{i} + {2}^{L} flag ) )}^{2} & {( 8 )}^{′}\end{matrix}$$

Here, L=|\vec{ }x|=|\vec{ }y|. Further, aᵢ is an auxiliary variable.

Constraint Equation SumLessThan

A constraint equation SumLessThan([\vec{ }x₀, \vec{ }x₁, . . . , xₙ₋₁], [\vec{ }y₀, \vec{ }y₁, . . . , \vec{ }yₘ₋₁], flag) is an equation indicating that Σ_{0≤i<n}#(\vec{ }x₁)<Σ_{0≤j<m}#(\vec{ }yⱼ) being valid for the quantum bytes \vec{ }x₀, \vec{ }x₁, . . . , xₙ₋₁, and \vec{ }y₀, \vec{ }y₁, . . . , \vec{ }yₘ₋₁ is equivalent to the quantum bit flag being 1, and the equation is calculated as follows.

$$\begin{matrix}[ Math . 14 ] & \\ S u m L essThan ( [ {\vec{x}}_{0} , {\vec{x}}_{1} , … , {\vec{x}}_{n - 1} ] , [ {\vec{y}}_{0} , {\vec{y}}_{1} , … , {\vec{y}}_{m - 1} ] , flag ) = {( ( {\sum }_{0 \leq i < n} \# ( {\vec{x}}_{i} ) - {\sum }_{0 \leq j < m} \# ( {\vec{y}}_{j} ) + {2}^{M} ) - ( {\sum }_{0 \leq i < M} {2}^{i} {a}_{i} + {2}^{M} ( 1 - flag ) ) )}^{2} & ( 9 )\end{matrix}$$

Here, L=|\vec{ }xᵢ|=|\vec{ }yⱼ|, and M=L+max(ceiling(log₂n), ceiling(log₂m)). Further, aᵢ is an auxiliary variable.

This constraint equation SumLessThan([\vec{ }x₀, \vec{ }x₁, . . . , \vec{ }xₙ₋₁], [\vec{ }y₀, \vec{ }y₁, . . . , \vec{ }yₘ₋₁], flag) can be derived by applying an idea of the constraint equation LessThan(\vec{ }x, \vec{ }y, flag).

Constraint Equation SumGreaterThan A constraint equation SumGreaterThan([\vec{ }x₀, \vec{ }x₁, . . . , \vec{ }xₙ₋₁], [\vec{ }y₀, \vec{ }y₁, . . . , \vec{ }yₘ₋₁], flag) is an equation indicating that Σ_{0≤i<n}#(\vec{ }x₁)>Σ_{0≤j<m}#(\vec{ }yⱼ) being valid for the quantum byte \vec{ }x₀, \vec{ }x₁, . . . , \vec{ }xₙ₋₁, and \vec{ }y₀, \vec{ }y₁, . . . , \vec{ }yₘ₋₁ is equivalent to the quantum bit flag being 1, and the equation is calculated as follows.

[Math. 15]

SumGreaterThan([\vec{x}₁, . . . ,\vec{x}ₙ₋₁][\vec{y}₀,\vec{y}₁, . . . ,\vec{y}ₘ₋₁], flag)=SumLessThan([\vec{y}₀,\vec{y}₁, . . . ,\vec{y}ₘ₋₁][\vec{x}₁,\vec{x}ₙ₋₁],flag) (10)

Using Equation (9), Equation (10) is transformed as follows.

[Math. 16]

$$\begin{matrix}[ Math . 16 ] & \\ SumGreaterThan ( [ {\vec{x}}_{0} , {\vec{x}}_{1} , … , {\vec{x}}_{n - 1} ] , [ {\vec{y}}_{0} , {\vec{y}}_{1} , … , {\vec{y}}_{m - 1} ] , flag ) = {( ( {\sum }_{0 \leq j < m} \# ( {\vec{y}}_{j} ) - {\sum }_{0 \leq i < n} \# ( {\vec{x}}_{i} ) + {2}^{M} ) - ( {\sum }_{0 \leq i < M} {2}^{i} {α}_{i} + {2}^{M} ( 1 - flag ) ) )}^{2} & {( 10 )}^{′}\end{matrix}$$

Here, L=|\vec{ }xᵢ|=|\vec{ }yⱼ|, and M=L+max(ceiling(log₂n), ceiling(log₂m)). Further, aᵢ is an auxiliary variable.

Constraint Equation SumLessThanEqual

A constraint equation SumLessThanEqual([\vec{ }x₀, \vec{ }x₁, . . . , \vec{ }xₙ₋₁], [\vec{ }y₀, \vec{ }y₁, . . . , \vec{ }yₘ₋₁], flag) is an equation indicating that Σ_{0≤i<n}#(\vec{ }x₁) Σ_{0≤j<m}#(\vec{ }yⱼ) being valid for the quantum bytes \vec{ }x₀, \vec{ }x₁, . . . , \vec{ }xₙ₋₁, and \vec{ }y₀, \vec{ }y₁, . . . , \vec{ }yₘ₋₁ is equivalent to the quantum bit flag being 1, and the equation is calculated as follows.

[Math. 17]

SumLessThanEqual([\vec{x}₀,\vec{x}₁, . . . ,\vec{x}ₙ₋₁],[\vec{y}₀,\vec{y}₁, . . . ,\vec{y}ₘ₋₁],flag)=SumGreaterThan([\vec{x}₀,\vec{x}₁,\vec{x}ₙ₋₁],[\vec{y}₀,\vec{y}₁, . . . ,\vec{y}ₘ₋₁],1−flag) (11)

Using Equation (9), Equation (11) is transformed as follows.

$$\begin{matrix}[ Math . 18 ] & \\ SumLessThanEqual ( [ {\vec{x}}_{0} , {\vec{x}}_{1} , … , {\vec{x}}_{n - 1} ] , [ {\vec{y}}_{0} , {\vec{y}}_{1} , … , {\vec{y}}_{m - 1} ] , flag ) = {( ( {\sum }_{0 \leq j < m} \# ( {\vec{y}}_{j} ) - {\sum }_{0 \leq i < n} \# ( {\vec{x}}_{i} ) + {2}^{M} ) - ( {\sum }_{0 \leq i < M} {2}^{i} {a}_{i} + {2}^{M} flag ) )}^{2} & {( 11 )}^{′}\end{matrix}$$

Here, L=|\vec{ }xᵢ|=|\vec{ }yⱼ|, and M=L+max(ceiling(log₂n), ceiling(log₂m)). Further, aᵢ is an auxiliary variable.

Constraint Equation SumGreaterThanEqual

A constraint equation SumGreaterThanEqual([\vec{ }x₀, \vec{ }x₁, . . . , xₙ₋₁], [\vec{ }y₀, \vec{ }y₁, . . . , \vec{ }yₘ₋₁], flag) is an equation indicating that Σ_{0≤i<n}#(\vec{ }x₁) Σ_{0≤j<m}#(\vec{ }yⱼ) being valid for the quantum bytes \vec{ }x₀, \vec{ }x₁, . . . , \vec{ }xₙ₋₁, \vec{ }y₀, \vec{ }y₁, . . . , \vec{ }yₘ₋₁ is equivalent to the quantum bit flag being 1, and the equation is calculated as follows.

[Math. 19]

SumGreaterThanEqual([\vec{x}₀,\vec{x}₁, . . . ,\vec{x}ₙ₋₁],[\vec{y}₀,\vec{y}₁, . . . ,\vec{y}ₘ₋₁],flag)=SumLessThan([\vec{x}₀,\vec{x}₁,\vec{x}ₙ₋₁],[\vec{y}₀,\vec{y}₁, . . . ,\vec{y}ₘ₋₁],1−flag) (12)

Using Equation (9), Equation (12) is transformed as follows.

$$\begin{matrix}[ Math . 20 ] & \\ SumGreaterThanEqual ( [ {\vec{x}}_{0} , {\vec{x}}_{1} , … , {\vec{x}}_{n - 1} ] , [ {\vec{y}}_{0} , {\vec{y}}_{1} , … , {\vec{y}}_{m - 1} ] , flag ) = {( ( {\sum }_{0 \leq i < n} \# ( {\vec{x}}_{i} ) - {\sum }_{0 \leq j < m} \# ( {\vec{y}}_{j} ) + {2}^{M} ) - ( {\sum }_{0 \leq i < M} {2}^{i} {a}_{i} + {2}^{M} flag ) )}^{2} & {( 12 )}^{′}\end{matrix}$$

Here, L=|\vec{ }xᵢ|=|\vec{ }yⱼ|, and M=L+max(ceiling(log₂n), ceiling(log₂m)). Further, aᵢ is an auxiliary variable.

Hereinafter, descriptions will be given on three specific examples of the combinatorial optimization problem to show that it is possible to design an optimization function for solving the combinatorial optimization problem by the above basic constraint equations.

Graph Coloring Problem

The graph coloring problem will be described herein. The graph coloring problem is a problem of coloring all areas separately on a constraint condition that one of C colors is assigned to an area such that any two adjacent areas have different colors assigned. Here, C is the number of colors used for coloring. Hereinafter, a constraint requiring that one of the C colors be assigned to an area is referred to as a first color constraint, and a constraint requiring that any two adjacent areas have different colors assigned is referred to as a second color constraint.

Next, input and output of the graph coloring problem will be described.

### (1) Input

The input of the graph coloring problem is as follows.
A set of color numbers indicating the colors used for coloring Sc={0, 1, . . . , C−1}
A set A of areas as coloring targets (hereinafter referred to as an area set)
Further, the following value is input for each area a ε A.
A set a.neighbors s A of areas adjacent to the area a

### (2) Output

The output of the graph coloring problem is as follows.
Color number c(a) ε Sc indicating a color assigned to each area a ε A
However, it is assumed that the color number c(a) satisfies the following conditions.

When b ε a.neighbors for each area a ε A, c(b)≠c(a) The quantum byte used to solve the graph coloring problem will be described. Here, the quantum byte is a sequence of quantum bits for encoding and expressing a plurality of states, and the quantum byte is a variable indicating a quantum state, which has a value of 1 or 0. In the graph coloring problem, the color number c (ε Sc) indicating the color assigned to the area a (ε A) is encoded and expressed as a quantum byte \vec{ }xₐ ε QByte(C).

Hereinafter, the objective function of QUBO will be described based on the above. Here, it is assumed that an equation indicating a certain constraint indicates a state in such a manner that the constraint is satisfied if the value of the equation is 0, and the constraint is not satisfied if the value of the equation is greater than 0. An objective function Coloring of QUBO is calculated as follows.

$$\begin{matrix}[ Math . 21 ] & \\ Coloring = {\sum }_{a ∈ A} {\sum }_{b ∈ a . n e i g h b o r s} Equal ( {\vec{x}}_{a} , {\vec{x}}_{b} , 0 ) & ( a1 )\end{matrix}$$

Here, a first term on the right side of Equation (a1) is an expression expressing the second color constraint. The first color constraint is satisfied from the definition of the quantum byte.

Scheduling Problem

A scheduling problem will be described herein. A scheduling problem is a problem of generating a plan of a process execution start time in which execution of all processes is completed by a predetermined time under predetermined constraint conditions. Here, the predetermined constraint conditions are “process order constraint” and “resource contention constraint”. Hereinafter, the “process order constraint” and the “resource contention constraint” will be described.
(1) Process order constraint
The process order constraint is a condition that, execution of any process is not be able to start until execution of all processes required to be completed before execution start of the process is completed.
(2) Resource contention constraint
The resource contention constraint is a condition that only one of processes requesting the same resources can be executed at one time.

Next, an input and output of the scheduling problem will be described.

### (1) Input

An input of the scheduling problem is as follows.
A set P of processes as plan generation targets (hereinafter referred to as a process set).
A set R of resources (hereinafter referred to as a resource set) required for execution by a process.
Time End when the execution of all processes included in the set P is required to be completed (hereinafter referred to as a maximum time. End is a predetermined constant).
Further, the following values are input for each process p ε P.
A required time p.time ε N (where N indicates a set of natural numbers) to execute the process p (execution time).
A set p.precede ⊆ P of processes (preceding processes) the execution of which is required to be completed before execution start of the process p.

Further, the following values are input for each resource r ε R.

A set of processes that require resource r for execution r.processes s P

### (2) Output

The output of the scheduling problem is as follows.
Execution start time start(p) of each process p ε P
Here, the execution start time start(p) is assumed to satisfy the following conditions (a), (b), and (c).
(a) Process completion constraint
The process completion constraint is a condition that each process is required to be completed by the maximum time End, and can be expressed as follows.

Start (p)+p.time≤End

(b) Process order constraint
The process order constraint is a condition that the execution of any process is not be able to start until execution of all processes required to be completed before execution start of the process is completed, and can be expressed as follows.

When q ε p.precede, start(q)+q.time≤start(p)

(c) Resource contention constraint
The resource contention constraint is a condition that only one of processes requesting the same resources can be executed at one time as described above, and can be expressed as follows.

When 0≤t≤End, {p ε r.processes|start(p)≤t≤start(p)+p.time}<1 (Here, S indicates the number of elements in a set S)

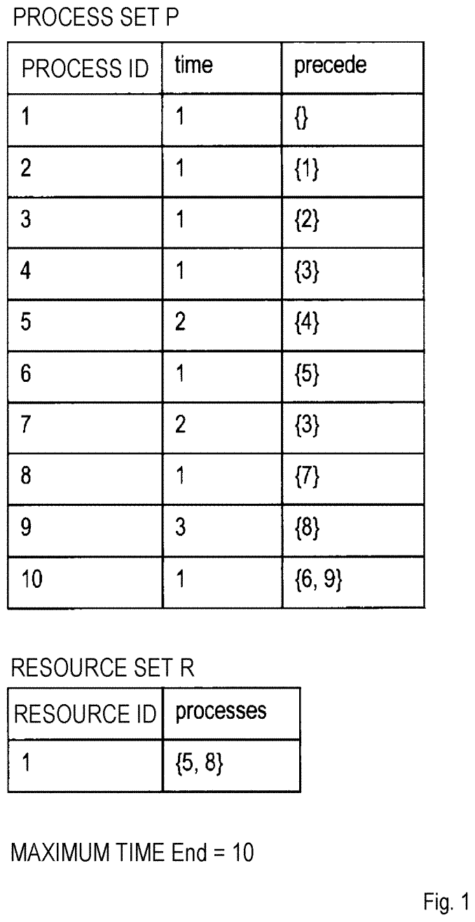

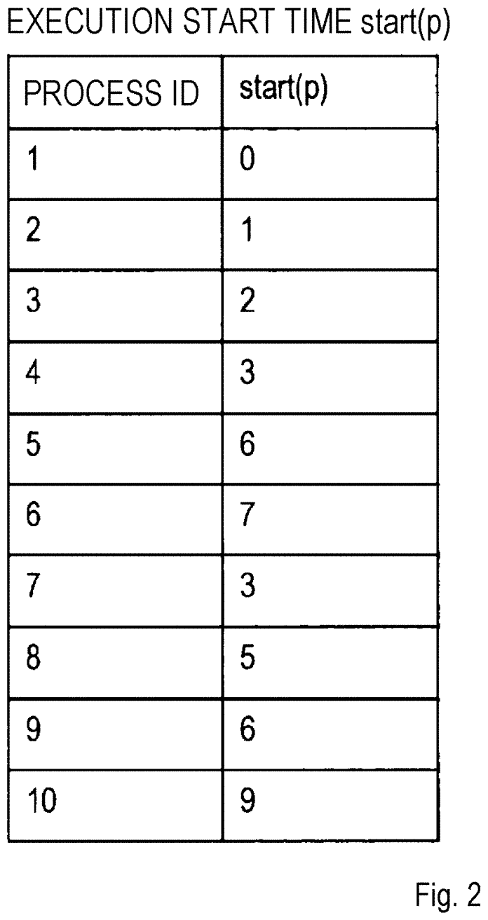

FIG. 1 illustrates an example of input of the scheduling problem. Further, FIG. 2 illustrates an example of the output of the scheduling problem.

The quantum byte used to solve the scheduling problem will be described. In the scheduling problem, an execution start time of the process p(EP) is encoded and expressed as a quantum byte \vec{ }xₚ ε QByte(End−p.time+1).

When \vec{ }xₚ ε QByte(End−p.time+1) is set, the process completion constraint is satisfied. In fact, it can be seen from \vec{ }xₚ ε QByte(End−p.time+1), that is, 0≤#(\vec{ }xₚ)<End−p.time+1, #(\vec{ }xₚ)+p.time≤End that the process completion constraint is satisfied.

Hereinafter, the objective function of QUBO based on the above will be described. Here, it is assumed that an equation indicating a certain constraint indicates a state in such a manner that the constraint is satisfied if the value of the equation is 0, and the constraint is not satisfied if the value of the equation is greater than 0. An objective function JSP of QUBO is calculated as follows.

[Math. 22]

JSP=Order+Resource (b1)

Here, Order is an equation indicating the process order constraint, and Resource is an equation indicating the resource contention constraint.

The equation Order, which indicates the process order constraint, is calculated as follows.

$$\begin{matrix}[ Math . 23 ] & \\ Order = {\sum }_{p ∈ P} {\sum }_{q ∈ p . p r e c e d e} SumLessThanEqual ( [ {\vec{x}}_{q} , q . time ] , [ {\vec{x}}_{p} ] , 1 ) & ( b2 )\end{matrix}$$

Equation (b2) will be described. Because [\vec{ }x_{q}, q.time] in the equation SumLessThanEqual indicates the execution completion time of the process q, and [\vec{ }xₚ]indicates the execution start time of the process p, SumLessThanEqual([\vec{ }x_{q}, q.time], [\vec{ }xₚ], 1) indicates that the execution completion time of the process q is before the execution start time of the process p. Thus, the equation Order indicates the process order constraint.

The equation Resource, which indicates the resource contention constraint, is calculated as follows.

$$\begin{matrix}[ Math . 24 ] & \\ Resource = {\sum }_{\begin{matrix}p , q ∈ r . proce s s e s \\ p < q\end{matrix}} Disjoint ( p , q ) & ( b3 )\end{matrix}$$

$$Disjoint ( p , q ) = Sum L e s s T h a n E q ual ( [ {\vec{x}}_{p} , p . time ] , [ {\vec{x}}_{q} ] , {a}_{p , q} ) + SumLessThanEqu al ( [ {\vec{x}}_{q} , q . time ] , [ {\vec{x}}_{p} ] , 1 - {a}_{p , q} ) \qquad ( b4 )$$

Here, a_{p, q} are auxiliary variables.

Equation (b3) will be described. Because a first term SumLessThanEqual([\vec{ }xₚ, p.time], [\vec{ }x_{q}], ap, q) on the right side of Equation (b4) indicates that “an execution completion time of the process p is before an execution start time of the process q⇔a_{p, q}=1” and a second term SumLessThanEqual([\vec{ }x_{q}, q.time], [\vec{ }xₚ], 1\vec{ }a_{p, q}) on the right side of Equation (b4) indicates that “an execution completion time of the process q is before an execution start time of the process p # a_{p, q}=0”, “the execution completion time of the process p is before an execution start time of the process q or the execution completion time of the process q is before an execution start time of the process p” is always satisfied, so that the execution time of the process p and the execution time of the process q do not overlap. Thus, the equation Resource indicates the resource contention constraint.

Bandwidth Allocation Planning Problem

Here, the bandwidth allocation planning problem is treated. The bandwidth allocation planning problem is a problem of generating a bandwidth allocation plan for a path satisfying a condition that a bandwidth allocated to the path is minimized as a whole (hereinafter referred to as an optimization condition) under a predetermined constraint condition. Here, the predetermined constraint condition is an “edge duplication constraint”. Hereinafter, the “edge duplication constraint” will be described.

(1) Edge duplication constraint

The edge duplication constraint is a condition that paths including the same edge do not share the same bandwidth.

Next, inputs and outputs of the bandwidth allocation planning problem will be described.

### (1) Input

The input of the bandwidth allocation planning problem is as follows.
A set Path of paths as plan generation targets (hereinafter referred to as a path set).
A set Edge of edges constituting a path (hereinafter referred to as an edge set).
A value Max in which an upper limit of a bandwidth allocated to the path (allocated bandwidth) must not exceeded (hereinafter referred to as a maximum bandwidth. Max is a predetermined constant).
Further, the following values are input for each path p ε Path.
Bandwidth p.bandwidth ε N (where N indicates a set of natural numbers) required by the path p (required bandwidth).
Further, the following values are input for each edge e ε Edge.
A set e.paths s Path of paths including edge.
A maximum bandwidth Max may be, for example, a sum of the required bandwidths of all the paths included in the path set Path. Thus, it is possible to prevent a solution of the bandwidth allocation planning problem from being not present.

### (2) Output

The output of the bandwidth allocation planning problem is as follows.
Lower limit bottom(p) of the allocated bandwidth of each path p ε Path.
Because the required bandwidth p.bandwidth is given to each path p, an upper limit of the allocated bandwidth can be obtained according to bottom(p)+p.bandwidth−1.
Here, bottom(p) shall satisfy the following conditions (a), (b), and (c). (a) Allocated bandwidth constraint
The allocated bandwidth constraint is a condition that the upper limit of the bandwidth allocated to each path does not exceed the maximum bandwidth Max, and can be expressed as follows.

bottom(p)+p.bandwidth−1≤Max

(b) Edge duplication constraint The edge duplication constraint is the condition that paths including the same edge do not share the same bandwidth as described above, and can be expressed as follows.
When 1≤b≤Max, |{p ε e.paths| bottom(p)≤b<bottom(p)+p.bandwidth}≤1 (where |S| indicates the number of elements in the set S).
(c) Optimization condition The optimization condition is a condition that the bandwidth allocated to the path of the set Path is minimized as a whole as described above, and can be expressed as follows.

minimize(l{b ε NJ for a bandwidth b, there is a path p ε Path satisfying bottom(p)≤b<bottom(p)+p.bandwidth})

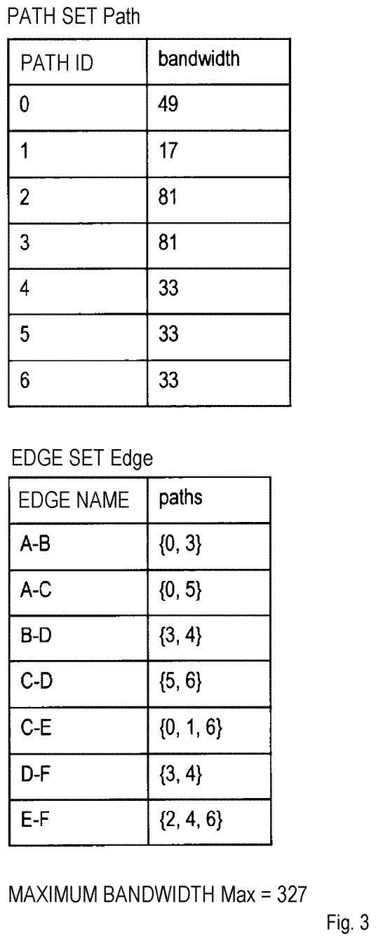

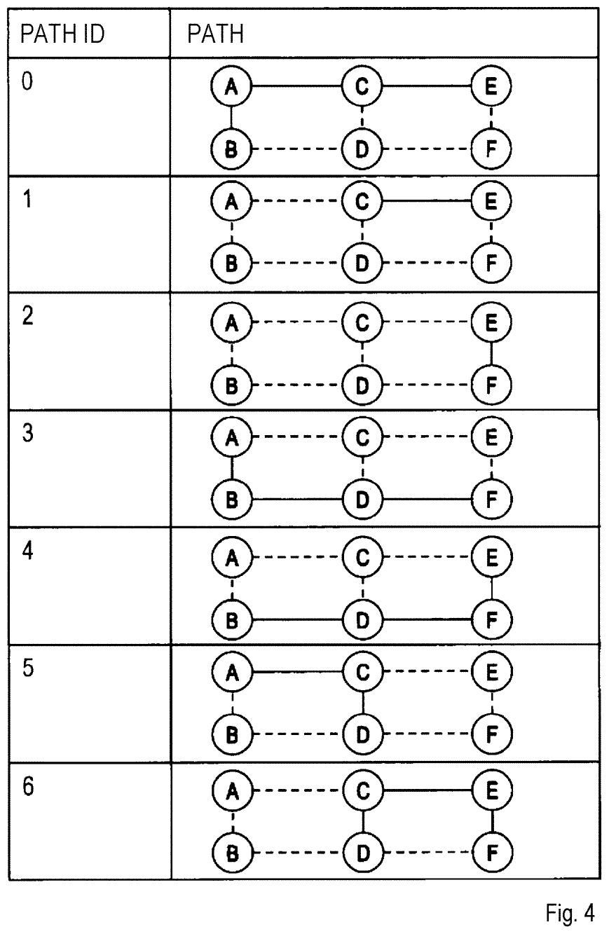

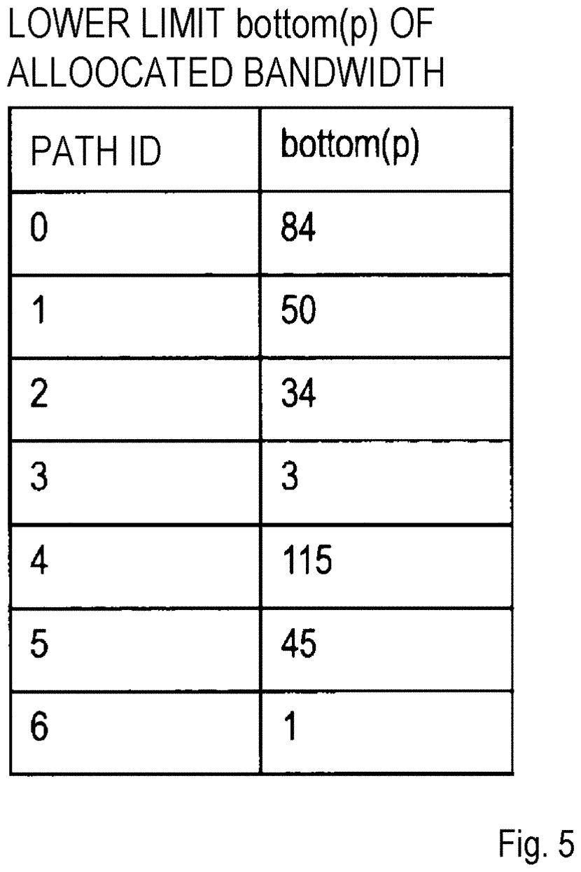

FIG. 3 illustrates an example of the input of the bandwidth allocation planning problem. FIG. 4 illustrates a relationship between a path and an edge of FIG. 3. Further, FIG. 5 illustrates an example of the output of the bandwidth allocation planning problem.

A quantum byte used to solve the bandwidth allocation planning problem will be described. In the bandwidth allocation planning problem, a number that is 1 smaller than a lower limit of the bandwidth allocated to the path p (ε P) is encoded and expressed as quantum byte \vec{ }xₚ ε QByte (Max−p.bandwidth+1).

The allocated bandwidth constraint is satisfied by setting \vec{ }xₚ ε QByte (Max−p.bandwidth+1). In fact, because p.bandwidth−1<#(\vec{ }xₚ)+p.bandwidth−1<Max, p.bandwidth<#(\vec{ }xₚ)+p.bandwidth<Max is derived from \vec{ }xₚ ε QByte (Max−p.bandwidth+1), that is, 0<#(\vec{ }xₚ)<Max−p.bandwidth+1, it can be seen that the allocated bandwidth constraint is satisfied.

Hereinafter, the objective function of QUBO will be described based on the above. Here, it is assumed that an equation indicating a certain constraint indicates a state in such a manner that the constraint is satisfied if the value of the equation is 0, and the constraint is not satisfied if the value of the equation is greater than 0. An objective function FlexGrid of QUBO is calculated as follows.

[Math. 25]

### FlexGrid

=Penalty*Restriction+Optimization (c1)

Restriction=Conflict (c2)

Here, Restriction is an equation indicating the constraint condition, Optimization is an equation indicating the minimization condition, and Penalty is a constant indicating a weight of the constraint condition Restriction. Further, Conflict is an equation indicating the edge duplication constraint.

Penalty may be, for example, 10000. When a value of Penalty is extremely greater than a value of the minimization condition Optimization, it is possible to tune the objective function FlexGrid of QUBO so that the constraint condition is preferentially satisfied.

The equation Conflict, which indicates the edge duplication constraint, is calculated as follows.

$$\begin{matrix}[ Math . 26 ] & \\ Conflicts = {\sum }_{e ∈ Edge} {\sum }_{\begin{matrix}p , q ∈ e . paths \\ p < q\end{matrix}} Disjoint ( p , q ) & ( c3 )\end{matrix}$$

$$Disjoint ( p , q ) = SumLessThan ( [ {\vec{x}}_{p} , p . bandwidth - 1 ] , [ {\vec{x}}_{q} ] , {a}_{p , q} ) + SumLessTha n ( [ {\vec{x}}_{q} , q . bandwidth - 1 ] , [ {\vec{x}}_{p} ] , 1 - {a}_{pq} ) \qquad ( c4 )$$

Here, a_{p, q} are auxiliary variables.

Equation (c3) will be described. A first term SumLessThanEqual([\vec{ }xₚ, p.bandwidth−1], [\vec{ }x_{q}],a_{p, q}) on the right side of Equation (c3) indicates that “upper limit of the allocated bandwidth of path p<lower limit of the allocated bandwidth of path q #a_{p, q}=1”. Further, a second term SumLessThanEqual([\vec{ }x_{q}, q.bandwidth−1], [\vec{ }xₚ], 1−a_{p, q}) on the right side of Equation (c3) indicates that “upper limit of bandwidth allocated of path q<lower limit of the allocated bandwidth of path q # a_{p, q}=0”. From these facts, because “the upper limit of the allocated bandwidth of the path p<the lower limit of the allocated bandwidth of the path q or the upper limit of the allocated bandwidth of the path q<the lower limit of the allocated bandwidth of the path p” is always satisfied, a bandwidth allocated to the path p and a bandwidth allocated to the path q do not overlap. Thus, the equation Conflict indicates the edge duplication constraint.

A minimization conditional equation Optimization is an equation for expressing “a maximum value of the upper limit of the allocated bandwidth of the path”, and is calculated as follows.

$$\begin{matrix}[ Math . 27 ] & \\ Optimization = \# ( \vec{a} ) + Max {\sum }_{p ∈ Path} SumLessThanEqual ( [ {\vec{x}}_{p} , p . bandwidth - 1 ] , [ \vec{a} ] , + 1 & ( c5 )\end{matrix}$$

Here, \vec{ }a satisfying \vec{ }a ε QByte (Max) is an auxiliary quantum byte.

Equation (c5) will be described. From the fact that \vec{ }a ε QByte (Max), that is, Max is greater than a value that #(\vec{ }a) can take, reducing the equation SumLessThanEqual([\vec{ }xₚ, p.bandwidth−1], [\vec{ }a], 1) appearing in a second term on the right side of (c5) is in preference to reducing #(\vec{ }a) that is a first term on the right side of Equation (c5), and #(\vec{ }a) is greater than or equal to a number that is 1 smaller than a upper limit of an allocated bandwidth of a certain path p. Further, #(\vec{ }a) is as small as possible. From these facts, #(\vec{ }a) is a number that is 1 smaller than the maximum value of the upper limit of the allocated bandwidth of the path. Thus, the minimization conditional equation Optimization is an equation for expressing “the maximum value of the upper limit of the allocated bandwidth of the path”, and a value thereof is obtained according to #(\vec{ }a)+1.

### First Embodiment

The optimization function generation apparatus 100 generates an optimization function for solving a combinatorial optimization problem.

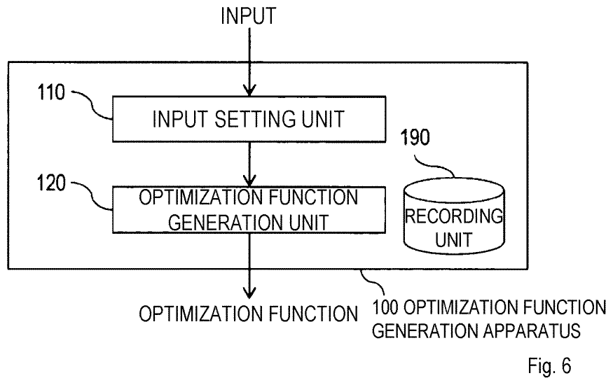

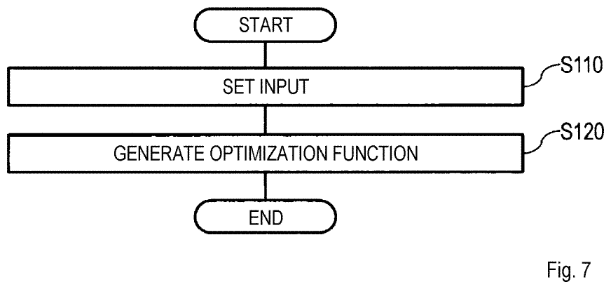

Hereinafter, the optimization function generation apparatus 100 will be described with reference to FIGS. 6 to 7. FIG. 6 is a block diagram illustrating a configuration of the optimization function generation apparatus 100. FIG. 7 is a flowchart illustrating an operation of the optimization function generation apparatus 100. As illustrated in FIG. 6, the optimization function generation apparatus 100 includes an input setting unit 110, an optimization function generation unit 120, and a recording unit 190. The recording unit 190 is a constituent unit that appropriately records information necessary for processing of the optimization function generation apparatus 100.

The operation of the optimization function generation apparatus 100 will be described with reference to FIG. 7.

In S110, the input setting unit 110 sets an input of the combinatorial optimization problem.

In S120, the optimization function generation unit 120 receives an input of the combinatorial optimization problem set in S110, uses the input to generate the optimization function for solving the combinatorial optimization problem, and outputs the optimization function. Here, the optimization function is a function designed using a quantum byte, which is a sequence of quantum bits indicating N states (N is an integer equal to or greater than 1) through encoding, and for the quantum byte \vec{ }x, an integer #(\vec{ }x) indicated by the quantum byte \vec{ }x is expressed by the following equation.

$$\begin{matrix}[ Math . 28 ] & \\ \# ( \vec{x} ) = {\sum }_{0 \leq i < ⌈ {log}_{2} N ⌉ - 1} {2}^{i} \vec{x} ( i ) + ( N - {2}^{⌈ {log}_{2} N ⌉ - 1} \vec{x} ( ⌈ {log}_{2} N ⌉ - 1 ) & \end{matrix}$$

(where, \vec{ }x(i) indicates a quantum bit of the i-th digit from the bottom when the quantum byte \vec{ }x is treated as a binary number) That is, the optimization function generation unit 120 sets preconditions that N is an integer equal to or greater than 1, Idx={0, . . . , N-1} is a set of indexes indicating N states, and i satisfies i εIdx, and generates an optimization function using a quantum byte obtained by performing encoding so that digits when the index i is expressed as a binary number each match a corresponding quantum bit included in a quantum byte, which is a sequence of log₂N quantum bits.

Further, the optimization function is generated using various basic constraint equations. Hereinafter, some constraint equations that can be used to generate the optimization function are illustrated.

The constraint equation Exist(\vec{ }x, flag) is an equation indicating that 1 being included in the quantum bits constituting the quantum byte \vec{ }x is equivalent to the quantum bit flag being 1, and the equation is calculated according to Equation (2).

The constraint equation ForAll(\vec{ }x, flag) is an equation indicating that all the quantum bits constituting the quantum byte \vec{ }x being 1 is equivalent to the quantum bit flag being 1, and is calculated according to Equation (3).

The constraint equation Equal(\vec{ }x, \vec{ }y, flag) is an equation indicating that #(\vec{ }x)=#(\vec{ }y) being valid for the quantum bytes \vec{ }x and \vec{ }y is equivalent to the quantum bit flag being 1, and the equation is calculated according to Equation (4).

The constraint equation LessThan(\vec{ }x, \vec{ }y, flag) is an equation indicating that #(\vec{ }x)<#(\vec{ }y) being valid for the quantum bytes \vec{ }x and \vec{ }y is equivalent to the quantum bit flag being 1, and the equation is calculated according to Equation (5). Further, the constraint equation LessThan (\vec{ }x, N, flag) is an equation indicating that #(\vec{ }x)<N being valid for the quantum byte \vec{ }x and an integer N is equivalent to the quantum bit flag being 1, and the equation is calculated according to Equation (5)′.

The constraint equation GreaterThan(\vec{ }x, \vec{ }y, flag) is an equation indicating that #(\vec{ }x)≥#(\vec{ }y) being valid for the quantum bytes \vec{ }x and \vec{ }y is equivalent to the quantum bit flag being 1, and the equation is calculated according to Equation (6)′.

The constraint equation LessThanEqual(\vec{ }x, \vec{ }y, flag) is an equation indicating that #(\vec{ }x)<#(\vec{ }y) being valid for the quantum bytes \vec{ }x and \vec{ }y is equivalent to the quantum bit flag being 1, and the equation is calculated according to Equation (7)′.

The constraint equation GreaterThan Equal(\vec{ }x, \vec{ }y, flag) is an equation indicating that #(\vec{ }x)≥#(\vec{ }y) being valid for the quantum bytes \vec{ }x and \vec{ }y is equivalent to the quantum bit flag being 1, and the equation is calculated according to Equation (8)′.

The constraint equation SumLessThan([\vec{ }x₀, \vec{ }x₁, . . . , \vec{ }xₙ₋₁], [\vec{ }y₀, \vec{ }y₁, . . . , \vec{ }yₘ₋₁], flag) is an equation indicating that Σ_{0≤i<n}#(\vec{ }x₁)<Σ_{0≤j<m}#(\vec{ }yⱼ) being valid for quantum bytes \vec{ }x₀, \vec{ }x₁, . . . , \vec{ }xₙ₋₁, and \vec{ }y₀, \vec{ }y₁, . . . , \vec{ }yₘ₋₁ is equivalent to the quantum bit flag being 1, and the equation is calculated according to Equation (9).

The constraint equation SumGreaterThan([\vec{ }x₀, \vec{ }x₁, . . . , \vec{ }xₙ₋₁], [\vec{ }y₀, \vec{ }y₁, . . . , yₘ₋₁], flag) is an equation indicating that Σ_{0≤i<n}#(\vec{ }x₁)≥Σ_{0≤j<m}#(\vec{ }yⱼ) being valid for the quantum bytes \vec{ }x₀, \vec{ }x₁, . . . , \vec{ }xₙ₋₁, and \vec{ }y₀, \vec{ }y₁, . . . , \vec{ }yₘ₋₁ is equivalent to the quantum bit flag being 1, and the equation is calculated according to Equation (10)′.

The constraint equation SumLessThanEqual([\vec{ }x₀, \vec{ }x₁, . . . , \vec{ }xₙ₋₁], [y₀, \vec{ }y₁, . . . yₘ₋₁], flag) is an equation indicating that Σ_{0≤i<n}#(\vec{ }x₁)<Σ_{0≤j<m}#(\vec{ }yⱼ) being valid for the quantum bytes \vec{ }x₀, \vec{ }x₁, . . . , \vec{ }xₙ₋₁, and \vec{ }y₀, \vec{ }y₁, . . . , \vec{ }yₘ₋₁ is equivalent to the quantum bit flag being 1, and the equation is calculated according to Equation (11)′.

The constraint equation SumGreaterThanEqual([\vec{ }x₀, \vec{ }x₁, . . . , \vec{ }xₙ₋₁], [\vec{ }y₀, \vec{ }y₁, . . . , \vec{ }yₘ₋₁], flag) is an equation indicating that Σ_{0≤i<n}#(\vec{ }x₁)≥Σ_{0≤j<m}#(\vec{ }yⱼ) being valid for the quantum bytes \vec{ }x₀, \vec{ }x₁, . . . , \vec{ }xₙ₋₁, and \vec{ }y₀, \vec{ }y₁, . . . , \vec{ }yₘ₋₁ is equivalent to the quantum bit flag being 1, and the equation is calculated according to Equation (12)′.

Hereinafter, a description will be given on a case in which the optimization function generation apparatus 100 is applied to a specific example of the combinatorial optimization problem.

Graph Coloring Problem

The optimization function generation apparatus 100 generates an optimization function for solving the graph coloring problem. Here, the graph coloring problem is a problem of coloring all areas separately on a constraint condition that one of C colors is assigned to an area such that any two adjacent areas have different colors assigned. Here, C is the number of colors used for coloring.

In S110, the input setting unit 110 receives a set Sc={0, 1, . . . , C-1} of color numbers (where C is the number of colors used for coloring), a set A of areas, and a set a.neighbors (⊆ A) of areas adjacent to the area a (ε A), and sets these pieces of data as the inputs of the graph coloring problem.

In S120, the optimization function generation unit 120 receives the input of the graph coloring problem set in S110, uses the input to generate the optimization function for solving the graph coloring problem, and outputs the optimization function. Here, the optimization function is a function designed by using the quantum byte \vec{ }xₐ ε QByte(C) obtained by encoding the color number c (ε Sc) indicating the color assigned to the area a (ε A), and specifically, is an objective function Coloring of QUBO calculated according to Equation (a1). For example, the set Sc of color numbers corresponds to a set Idx of indexes.

Scheduling Problem

The optimization function generation apparatus 100 generates an optimization function for solving a scheduling problem. Here, the scheduling problem is a problem of generating a plan of the process execution start time in which execution of all the processes included in the process set P is completed by the maximum time End under predetermined constraint conditions. Further, one of the predetermined constraints is the process order constraint described in the Technical Background, that is, a condition that start(q)+q.time≤start(p) is satisfied for the processes p ε P, and q ε p.precede (where start(p) indicates the execution start time of the process p) (hereinafter referred to as a first constraint condition). The other of the predetermined constraints is the resource contention constraint, that is, a condition that {p ε r.processesstart(p)≤t≤start(p)+p.time}≤1 is satisfied for each time t until the maximum time End and resource r ε R (hereinafter referred to as a second constraint condition).

In S110, the input setting unit 110 receives the process set P, the resource set R, the maximum time End, a time p.time required to execute the process p (ε P), a set p.precede (⊆ P) of processes the execution of which is required to be completed before execution start of the process p, and a set r.processes (⊆ P) requiring a resource r (ε R) for execution, and sets these pieces of input as inputs of the scheduling problem.

In S120, the optimization function generation unit 120 receives an input of the scheduling problem set in S110, uses the input to generate the optimization function for solving the scheduling problem, and outputs the optimization function. Here, the optimization function is a function designed by using the quantum byte \vec{ }xₚ ε QByte(End−p.time+1) obtained by encoding the execution start time of the process p (ε P), and specifically, is an objective function JSP of QUBO calculated according to Equation (b1). For example, the set {0, . . . , End} corresponds to the set Idx of indexes.

Bandwidth Allocation Planning Problem

The optimization function generation apparatus 100 generates an optimization function for solving the bandwidth allocation planning problem. Here, the bandwidth allocation planning problem is a problem of generating a bandwidth allocation plan for a path satisfying a condition that a bandwidth allocated to a path of the set Path is minimized as a whole (hereinafter referred to as an optimization condition) under a predetermined constraint condition. Further, the predetermined constraint condition is the edge duplication constraint described in the Technical Background, that is, a condition that |{p ε e.pathsbottom(p)≤b<bottom(p)+p.bandwidth}|≤1 (where, bottom(p) indicates the lower limit of the bandwidth allocated to the path p) is satisfied for each bandwidth b up to a maximum bandwidth Max and edge e ε Edge (hereinafter referred to as a first constraint condition).

In S110, the input setting unit 110 receives a set Path of paths, a set Edge of edges, a maximum bandwidth Max, a bandwidth p.bandwidth required by the path p (ε Path), and a set e.paths (⊆ Path) of paths including an edge e (ε Edge), and sets these pieces of data as inputs of the bandwidth allocation planning problem.

In S120, the optimization function generation unit 120 receives an input of the bandwidth allocation planning problem set in S110 as an input, uses the input to generate the optimization function for solving the bandwidth allocation planning problem, and outputs the optimization function. Here, the optimization function is a function designed by using the quantum byte \vec{ }xₚ ε QByte(Max−p.bandwidth+1) obtained by encoding a number that is 1 smaller than the lower limit of the bandwidth allocated to the path p (ε P) and specifically, is the objective function FlexGrid of QUBO calculated according to Equation (c1). For example, the set {0, . . . , Max} corresponds to the set Idx of indexes.

The optimization function that is an output of the optimization function generation apparatus 100 is input to, for example, a quantum annealing machine or an Ising machine, and processed by these machines so that a solution to the bandwidth allocation planning problem can be obtained.

According to the embodiment of the present invention, it is possible to generate an optimization function for solving a combinatorial optimization problem, which can be expressed using fewer quantum bits.

Supplements

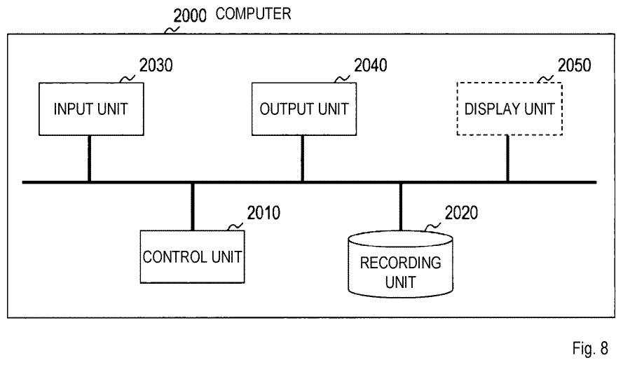

FIG. 8 is a diagram illustrating an example of a functional configuration of a computer that realizes each of the above-described apparatuses. The processing in each of the above-described apparatuses can be performed by causing a recording unit 2020 to read a program for causing the computer to function as each of the above-described apparatuses, and causing the program to be operated in a control unit 2010, an input unit 2030, an output unit 2040, and the like.

The apparatus of the present invention includes, for example, as single hardware entities, an input unit to which a keyboard or the like can be connected, an output unit to which a liquid crystal display or the like can be connected, a communication unit to which a communication device (for example, a communication cable) capable of communicating with the hardware entities can be connected, a central processing unit (CPU, which may include a cache memory, a register, or the like), a RAM or ROM that is a memory, an external storage device that is a hard disk, and a bus that connects the input unit, the output unit, the communication unit, the CPU, the RAM, the ROM, and the external storage device so that data can be exchanged therebetween. Further, a device (drive) capable of reading and writing a recording medium such as a CD-ROM, for example, may be provided in the hardware entity, as necessary. A physical entity including such hardware resources includes a general-purpose computer and the like.

Programs required for realization of the above-described functions, data required for processing of the programs, and the like are stored in the external storage device of the hardware entity (the present invention is not limited to an external storage device, and for example, the programs may be read out and stored in a ROM, which is a dedicated storage device). Further, data and the like obtained by the processing of the programs is appropriately stored in a RAM, an external storage device, or the like.

In the hardware entity, each program stored in the external storage device (or ROM or the like) and the data necessary for processing each program are read into a memory as necessary, and are appropriately interpreted, executed, and processed by the CPU. As a result, the CPU realizes a predetermined function (each component represented by the unit, means, or the like described above).

The present invention is not limited to the above-described embodiments, and can be appropriately changed without departing from the spirit of the present invention. Further, the processing described in the embodiment may be not only executed in chronological order according to a describing order, but may also be executed in parallel or individually using the processing capability of a device that executes the processing or necessity.

As described above, when a processing function in the hardware entity (the apparatus of the present invention) described in the above embodiment is realized by a computer, processing content of functions that the hardware entity needs to have are described by a program. A processing function in the above hardware entity is realized on the computer by executing this program on the computer.

A program in which processing content thereof has been described can be recorded on a computer-readable recording medium. The computer-readable recording medium may be, for example, a magnetic recording device, an optical disc, a magneto-optical recording medium, or a semiconductor memory. Specifically, for example, a hard disk device, a flexible disk, a magnetic tape, or the like can be used as the magnetic recording device, a digital versatile disc (DVD), a DVD-random access memory (RAM), a compact disc read only memory (CD-ROM), CD-R (Recordable)/RW (ReWritable), or the like can be used as the optical disc, a magneto-optical disc (MO) or the like can be used as the magneto-optical recording medium, and an electrically erasable and programmable-read only memory (EEPROM) or the like can be used as the semiconductor memory.

Further, distribution of this program is performed, for example, by selling, transferring, or renting a portable recording medium such as a DVD or CD-ROM on which the program has been recorded. Further, the program may be distributed by being stored in a storage device of a server computer and transferred from the server computer to another computer via a network.

The computer that executes such a program first temporarily stores, for example, the program recorded on the portable recording medium or the program transferred from the server computer in a storage device of the computer. When the computer executes the processing, the computer reads the program stored in the recording medium of the computer and executes processing according to the read program. Further, as another embodiment of the program, the computer may directly read the program from the portable recording medium and execute the processing according to the program, and further, processing according to a received program may be sequentially executed each time the program is transferred from the server computer to the computer. Further, a configuration may be adopted in which the above-described processing is executed by a so-called application service provider (ASP) type service for realizing a processing function according to only an execution instruction and result acquisition without transferring the program from the server computer to the computer. It is assumed that the program in the present embodiment includes information provided for processing of an electronic calculator and being pursuant to the program (such as data that is not a direct command to the computer, but has properties defining processing of the computer).

Further, although the hardware entity is configured by a predetermined program being executed on the computer in this embodiment, at least a part of processing content of thereof may be realized by hardware.

The above-described embodiment of the present invention is presented for the purpose of illustration and description. There is no intention to be exhaustive and there is no intention to limit the invention to a disclosed exact form. Modifications or variations are possible from the above-described teachings. The embodiments are selectively represented in order to provide the best illustration of the principle of the present invention and in order for those skilled in the art to be able to use the present invention in various embodiments and with various modifications so that the present invention is suitable for deliberated practical use. All of such modifications or variations are within the scope of the present invention defined by the appended claims interpreted according to a width given fairly, legally and impartially.

1. An optimization function generation apparatus comprising:
input setting circuitry configured to set an input of a combinatorial optimization problem; and
optimization function generation circuitry configured to generate an optimization function for solving the combinatorial optimization problem using the input,
wherein N is an integer equal to or greater than 1, Idx={0, . . . , N-1} is a set of indexes indicating N states, and i satisfies i εIdx, and
the optimization function generation circuitry generates the optimization function using a quantum byte obtained by performing encoding so that digits when an index i is expressed as a binary number each match a corresponding quantum bit included in a quantum byte, the quantum byte being a sequence of log₂N quantum bits.

2. The optimization function generation apparatus according to claim 1, wherein the optimization function generation circuitry generates the optimization function using a constraint equation Exist(\vec{ }x, flag), the constraint equation being an equation indicating that 1 being included in quantum bits constituting a quantum byte \vec{ }x is equivalent to a quantum bit flag being 1.

3. The optimization function generation apparatus according to claim 1, wherein the optimization function generation circuitry generates the optimization function using a constraint equation ForAll(\vec{ }x, flag), the constraint equation being an equation indicating that all quantum bits constituting a quantum byte \vec{ }x being 1 is equivalent to a quantum bit flag being 1.

4. The optimization function generation apparatus according to claim 1, wherein the optimization function generation circuitry generates the optimization function using a constraint equation Equal(\vec{ }x, \vec{ }y, flag), the constraint equation being an equation indicating that #(\vec{ }x)=#(\vec{ }y) being valid for quantum bytes \vec{ }x and \vec{ }y is equivalent to a quantum bit flag being 1.

5. The optimization function generation apparatus according to claim 1, wherein the optimization function generation circuitry generates the optimization function using a constraint equation LessThan(\vec{ }x, \vec{ }y, flag), the constraint equation being an equation indicating that #(\vec{ }x)<#(\vec{ }y) being valid for quantum bytes \vec{ }x and \vec{ }y is equivalent to a quantum bit flag being 1.

6. The optimization function generation apparatus according to claim 1, wherein the optimization function generation circuitry generates the optimization function using a constraint equation LessThan (\vec{ }x, N, flag), the constraint equation being an equation indicating that #(\vec{ }x)<N being valid for a quantum byte \vec{ }x and an integer N is equivalent to a quantum bit flag being 1.

7. The optimization function generation apparatus according to claim 1, wherein the optimization function generation circuitry generates the optimization function using a constraint equation GreaterThan(\vec{ }x, \vec{ }y, flag), the constraint equation being an equation indicating that #(\vec{ }x)≥#(\vec{ }y) being valid for quantum bytes \vec{ }x and \vec{ }y is equivalent to a quantum bit flag being 1.

8. The optimization function generation apparatus according to claim 1, wherein the optimization function generation circuitry generates the optimization function using a constraint equation LessThanEqual(\vec{ }x, \vec{ }y, flag), the constraint equation being an equation indicating that #(\vec{ }x)<#(\vec{ }y) being valid for quantum bytes \vec{ }x and \vec{ }y is equivalent to a quantum bit flag being 1.

9. The optimization function generation apparatus according to claim 1, wherein the optimization function generation circuitry generates the optimization function using a constraint equation GreaterThan Equal(\vec{ }x, \vec{ }y, flag), the constraint equation being an equation indicating that #(\vec{ }x)≥#(\vec{ }y) being valid for quantum bytes \vec{ }x and \vec{ }y is equivalent to a quantum bit flag being 1.

10. The optimization function generation apparatus according to claim 1, wherein the optimization function generation circuitry generates the optimization function using a constraint equation SumLessThan([\vec{ }x₀, \vec{ }x₁, . . . , \vec{ }xₙ₋₁], [\vec{ }y₀, \vec{ }y₁, . . . , \vec{ }yₘ₋₁], flag), the constraint equation being an equation indicating that Σ_{0≤j<n}#(\vec{ }x₁)<Σ_{0≤j<m}#(\vec{ }yⱼ) being valid for quantum bytes \vec{ }x₀, \vec{ }x₁, . . . , xₙ₋₁, and \vec{ }y₀, \vec{ }y₁, . . . , yₘ₋₁ is equivalent to a quantum bit flag being 1.

11. The optimization function generation apparatus according to claim 1, wherein the optimization function generation circuitry generates the optimization function using a constraint equation SumGreaterThan([\vec{ }x₀, x₁, . . . , xₙ₋₁], [\vec{ }y₀, \vec{ }y₁, . . . , \vec{ }yₘ₋₁], flag), the constraint equation being an equation indicating that Σ_{0≤j<n}#(\vec{ }x₁)≥Σ_{0≤j<m}#(\vec{ }yⱼ) being valid for quantum bytes x₀, \vec{ }x₁, . . . , xₙ₋₁, and \vec{ }y₀, \vec{ }y₁, . . . , \vec{ }yₘ₋₁ is equivalent to a quantum bit flag being 1.

12. The optimization function generation apparatus according to claim 1, wherein the optimization function generation circuitry generates the optimization function using a constraint equation SumLessThanEqual([\vec{ }x₀, \vec{ }x₁, . . . , \vec{ }xₙ₋₁], [\vec{ }y₀, \vec{ }y₁, . . . , \vec{ }yₘ₋₁], flag), the constraint equation indicating that Σ_{0≤j<n}#(\vec{ }x₁) Σ_{0≤j<m}#(\vec{ }yⱼ) being valid for quantum bytes \vec{ }x₀, \vec{ }x₁, . . . , \vec{ }xₙ₋₁, \vec{ }y₀, \vec{ }y₁, . . . , \vec{ }yₘ₋₁ is equivalent to a quantum bit flag being 1.

13. The optimization function generation apparatus according to claim 1, wherein the optimization function generation circuitry generates the optimization function using a constraint equation SumGreaterThanEqual([\vec{ }x₀, \vec{ }x₁, . . . , \vec{ }xₙ₋₁], [\vec{ }y₀, \vec{ }y₁, . . . , \vec{ }yₘ₋₁], flag), the constraint equation indicating that Σ_{0≤j<n}#(\vec{ }x₁);≥Σ_{0≤j<m}#(\vec{ }yⱼ) being valid for quantum bytes \vec{ }x₀, \vec{ }x₁, . . . , xₙ₋₁, and \vec{ }y₀, \vec{ }y₁, . . . , \vec{ }yₘ₋₁ is equivalent to a quantum bit flag being 1.

14. The optimization function generation apparatus according to claim 1,
wherein the combinatorial optimization problem is a graph coloring problem,
the input includes a set Sc={0, 1, . . . , C−1} of color numbers (where C is the number of colors used for coloring), a set A of areas, and a set a.neighbors (⊆ A) of areas adjacent to an area a (ε A), and
the optimization function is a function designed by using a quantum byte \vec{ }xₐ E QByte(C) obtained by encoding a color number c (ε Sc) indicating a color assigned to the area a (ε A).

15. The optimization function generation apparatus according to claim 1,
wherein the combination optimization problem is a scheduling problem of generating a plan for an execution start time of a process in which execution of all processes included in the set P is completed by a maximum time End under a predetermined constraint condition,
the input includes a process set P, a resource set R, a maximum time End, a time p.time required to execute a process p (ε P), a set p.precede (⊆ P) of processes of which the execution is required to be completed before execution start of the process p, and a set r.processes (⊆ P) of processes requiring a resource r (ε R) for execution, and
the optimization function is a function designed by using a quantum byte \vec{ }xₚ ε QByte(End−p.time+1) obtained by encoding an execution start time of the process p (ε P).

16. The optimization function generation apparatus according to claim 1,
wherein the combinatorial optimization problem is a bandwidth allocation planning problem of generating a bandwidth allocation plan for a path satisfying a condition that a bandwidth allocated to a path of a set Path is minimized as a whole under a predetermined constraint condition,
the input includes a set Path of paths, a set Edge of edges, a maximum bandwidth Max, a bandwidth p.bandwidth required by the path p (ε Path), and a set e.paths (⊆ Path) of paths including an edge e (ε Edge), and
the optimization function is a function designed by using a quantum byte \vec{ }xₚ E QByte(Max−p.bandwidth+1) obtained by encoding a number that is 1 smaller than a lower limit of a bandwidth allocated to the path p (ε P).

17. An optimization function generation method comprising:
setting, by an optimization function generation apparatus, an input of a combinatorial optimization problem; and
generating, by the optimization function generation apparatus, an optimization function for solving the combinatorial optimization problem using the input,
wherein N is an integer equal to or greater than 1, Idx={0, . . . , N−1} is a set of indexes indicating N states, and i satisfies i εIdx, and
in the generating, a quantum byte obtained by performing encoding so that digits when an index i is expressed as a binary number each match a corresponding quantum bit included in a quantum byte, the quantum byte being a sequence of log₂N quantum bits.

18. A non-transitory computer readable medium storing a program for causing a computer to function as the optimization function generation apparatus according to claim 1.

19. A non-transitory computer readable medium storing a program for causing a computer to perform the steps of claim 17.
